(19) United States
(12) Patent Application Publication
(10) Pub. No.: US 2024/0411246 A1
(43) Pub. Date: Dec. 12, 2024

(54) IMAGE FORMING APPARATUS

(71) Applicant: FUJI FILM Business Innovation Corp., Tokyo (JP)

(72) Inventors: Makoto OCHIAI, Ebina-shi, (JP); Ayumi NOGUCHI, Ebina-shi, (JP); Naoki NOGAMI, Ebina-shi, (JP); Hideki OKAMOTO, Ebina-shi, (JP); Koichiro YUASA, Ebina-shi, (JP); Jun KUWABARA, Ebina-shi, (JP)

(73) Assignee: FUJI FILM Business Innovation Corp., Tokyo (JP)

(21) Appl. No.: 18/517,920

(22) Filed: Nov. 22, 2023

(30) Foreign Application Priority Data
Jun. 9, 2023 (JP) 2023-095880

(51) Int. Cl. G03G 15/16

(52) U.S. Cl. CPC G03G 15/161

(57) ABSTRACT

An image forming apparatus includes: a transport member that moves in a circumferential direction, forms a transfer nip while transporting a medium between the transport member and an image carrier holding a toner image, and transfers the toner image to the medium, the transport member including a plurality of grooves along the circumferential direction; and a cleaning member that cleans a surface of the transport member, collects an adherent substance, and includes a plurality of projections and recesses extending in a direction intersecting the grooves on a contact surface with the transport member.

### CROSS-REFERENCE TO RELATED APPLICATIONS

This application is based on and claims priority under 35 USC 119 from Japanese Patent Application No. 2023-095880 filed Jun. 9, 2023.

### BACKGROUND

### (i) Technical Field

The present disclosure relates to an image forming apparatus.

### (ii) Related Art

JP2013-174757A listed below discloses an endless transfer belt that holds a developer image, the transfer belt including a base layer, an elastic layer that includes an elastic material and a filler dispersed in the elastic material and is laminated on an outer side of the base layer, and a surface layer laminated on an outer side of the elastic layer, the transfer belt satisfying 0.05 [μm]≤Rz≤1.21 [μm] 0.1≤μs≤1.0 where Rz represents a ten-point average roughness of a surface of the surface layer and μs represents static friction coefficient of the surface of the surface layer.

JP2010-271380A listed below discloses an image forming apparatus including an endless belt as a toner image carrier that holds and transports a toner image, a belt stretching unit that includes a plurality of rolls including a driving roller for stretching and transporting the endless belt, and a cleaning member for collecting residual toner on the endless belt using at least one of the rollers as a counter roller, the image forming apparatus being provided with the endless belt having polishing marks in a circumferential direction of a surface of the endless belt.

JP2005-082327A listed below discloses an endless belt stretched over a plurality of rollers, the endless belt being provided with a groove extending in an endless longitudinal direction on an outer circumferential surface.

### SUMMARY

Aspects of non-limiting embodiments of the present disclosure relate to an image forming apparatus capable of suppressing deterioration due to abrasion while improving cleaning performance of a transport member as compared with a case where a plurality of grooves and projections and recesses do not intersect each other on a contact surface between the transport member including the grooves in a circumferential direction and a cleaning member including the projections and recesses.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus comprising: a transport member that moves in a circumferential direction, forms a transfer nip while transporting a medium between the transport member and an image carrier holding a toner image, and transfers the toner image to the medium, the transport member including a plurality of grooves along the circumferential direction; and a cleaning member that cleans a surface of the transport member, collects an adherent substance, and includes a plurality of projections and recesses extending in a direction intersecting the grooves on a contact surface with the transport member.

### BRIEF DESCRIPTION OF THE DRAWINGS

FIG. 1 is a schematic diagram illustrating a configuration of an image forming apparatus according to a first embodiment as viewed from the front side.

FIG. 2 is a schematic configuration diagram illustrating a cleaning device for a secondary transfer belt used in the image forming apparatus according to the first embodiment.

FIG. 3 is a schematic configuration diagram illustrating a state in which a cleaning brush of the cleaning device is in contact with the secondary transfer belt.

FIG. 4A is a schematic side view illustrating the cleaning brush, and FIG. 4B is a partial cross-sectional view illustrating a state in which a part of the cleaning brush is cut along an axial direction.

FIG. 5A is a schematic configuration diagram illustrating a contact portion between the cleaning brush and the secondary transfer belt, and FIG. 5B is a view schematically illustrating a direction of projections and recesses of the cleaning brush and a direction of a groove of a belt member.

FIG. 6 is a schematic configuration diagram illustrating a state in which a cleaning brush of a cleaning device used in an image forming apparatus according to a second embodiment is in contact with a secondary transfer belt.

FIG. 7 is a schematic configuration diagram illustrating a contact portion between the cleaning brush used in the image forming apparatus according to the second embodiment and the secondary transfer belt.

FIG. 8 is a schematic configuration diagram illustrating a cleaning device for a secondary transfer belt used in an image forming apparatus according to a third embodiment.

FIG. 9 is a side view illustrating a cleaning roller of the cleaning device and an enlarged side view in which a part of the cleaning roller is enlarged.

FIG. 10 is a partial cross-sectional view illustrating a state in which a part of the cleaning roller is cut along an axial direction.

FIG. 11 is a schematic configuration diagram illustrating a cleaning brush of a cleaning device used in an image forming apparatus according to a fourth embodiment.

FIG. 12A is a view schematically illustrating a direction of projections and recesses of divided portions at both ends of the secondary transfer belt in a width direction and a direction of a groove of the secondary transfer belt; and FIG. 12B is a view schematically illustrating a direction of projections and recesses of a divided portion at a center portion of the secondary transfer belt in the width direction and the direction of the groove of the secondary transfer belt.

### DETAILED DESCRIPTION

Hereinafter, exemplary embodiments of the present invention will be described with reference to the drawings. Note that an arrow H illustrated in each drawing indicates a vertical direction, and an arrow W indicates a horizontal direction which is an apparatus width direction.

### First Embodiment

An image forming apparatus according to a first embodiment will be described hereinafter.

### <Configuration of Image Forming Apparatus>

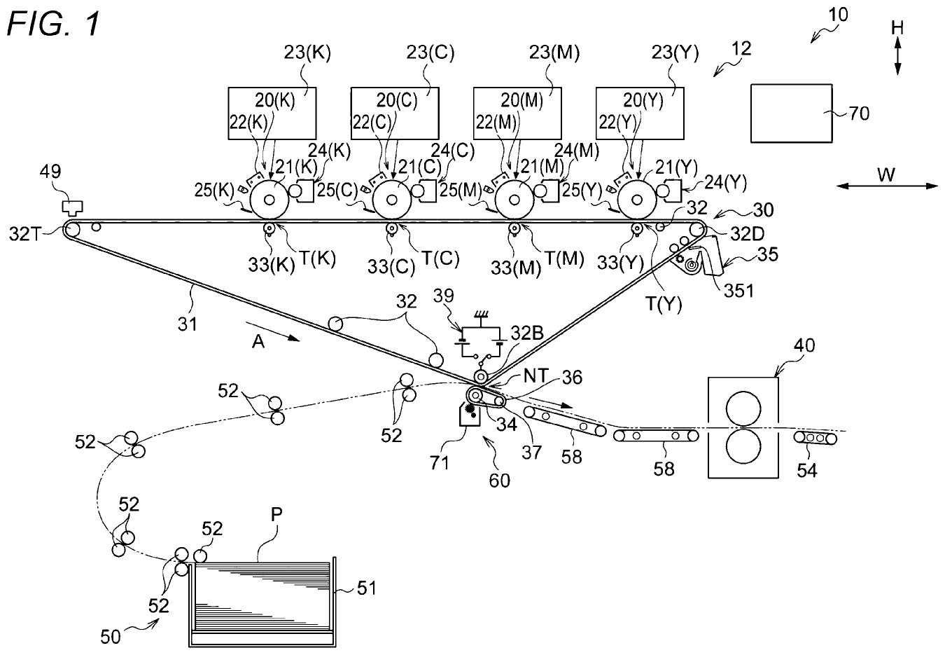

FIG. 1 is a schematic diagram illustrating a configuration of an image forming apparatus 10 as viewed from the front side. As illustrated in FIG. 1, the image forming apparatus 10 includes an image forming unit 12 that forms an image on a recording medium P such as paper by an electrophotographic method, a transport device 50 that transports the recording medium P, and a control unit 70 that controls operations of the respective units of the image forming apparatus 10. The recording medium P is an example of a medium.

### (Transport Device)

As illustrated in FIG. 1, the transport device 50 includes a container 51 that contains the recording medium P and a plurality of transport rollers 52 that transport the recording medium P from the container 51 to a secondary transfer position NT. Further, the transport device 50 includes a plurality of transport belts 58 that transport the recording medium P from the secondary transfer position NT to a fixing device 40, and a transport belt 54 that transports the recording medium P from the fixing device 40 toward a discharge unit (not illustrated) of the recording medium P.

### (Image Forming Unit)

The image forming unit 12 includes a toner image forming unit 20 that forms a toner image, a transfer device 30 that transfers the toner image formed by the toner image forming unit 20 to the recording medium P, and the fixing device 40 that fixes the toner image, which has been transferred to the recording medium P, to the recording medium P by applying heat and pressure.

A plurality of the toner image forming units 20 are provided to form a toner image per color. In this embodiment, the toner image forming units 20 of a total of four colors of yellow (Y), magenta (M), cyan (C) and black (K) are provided. The toner image forming units 20 of the respective colors are disposed in the order of yellow (Y), magenta (M), cyan (C), and black (K) from the upstream side to the downstream side in a transport direction of an intermediate transfer belt 31 to be described later.

In FIG. 1, (Y), (M), (C), and (K) indicate constituent portions corresponding to the respective colors. In the description of the specification, Y, M, C, and K may be described by omitting parentheses of (Y), (M), (C), and (K).

### [Toner Image Forming Unit]

The toner image forming units 20 of the respective colors are basically configured in the same manner except for toners to be used. In the following description, when it is not necessary to distinguish the respective colors from one another, (Y), (M), (C), and (K) are omitted, and only references of the respective members are simply described. Specifically, the toner image forming unit 20 of each color includes a photosensitive drum 21 that rotates in the clockwise direction, a charger 22 that charges the photosensitive drum 21, and an exposure device 23 that exposes the photosensitive drum 21 charged by the charger 22 to light to form an electrostatic latent image on the photosensitive drum 21. The toner image forming unit 20 of each color further includes a developing device 24 that develops the electrostatic latent image, which has been formed on the photosensitive drum 21 by the exposure device 23, to form a toner image, and a blade 25 that removes a toner remaining on a surface of the photosensitive drum 21 after the toner image is transferred to the transfer device 30.

For example, the charger 22 charges the surface (photosensitive layer) of the photosensitive drum 21 to a negative polarity. On the surface of the photosensitive drum 21 charged to the negative polarity, a portion irradiated with exposure light L by the exposure device 23 exhibits a positive polarity, and an electrostatic latent image is formed on the surface of the photosensitive drum 21. Then, a toner frictionally charged to the negative polarity in the developing device 24 adheres to the electrostatic latent image having the positive polarity so that the electrostatic latent image is developed. In this manner, a toner image is formed on the surface (outer circumferential surface) of the photosensitive drum 21. The blade 25 comes into contact with the surface of the photosensitive drum 21 and scrapes off the toner remaining on the surface of the photosensitive drum 21.

### [Transfer Device]

The transfer device 30 primarily transfers the toner images on the photosensitive drums 21 of the respective colors onto the intermediate transfer belt 31 in a superimposed manner, and secondarily transfers the superimposed toner images onto the recording medium P at the secondary transfer position NT (an example of a nip). Specifically, the transfer device 30 includes the intermediate transfer belt 31, primary transfer rollers 33, a secondary transfer belt 36, a cleaning device 60 for the secondary transfer belt 36, and a cleaning device 35 for the intermediate transfer belt 31. The secondary transfer belt 36 is an example of a transport member that forms a transfer nip while transporting the recording medium P between the secondary transfer belt 36 and the intermediate transfer belt 31. Further, the secondary transfer belt 36 can also be an example of a transfer member that transfers the toner images held on the intermediate transfer belt 31 to the recording medium P.

### [Intermediate Transfer Belt]

As illustrated in FIG. 1, the intermediate transfer belt 31 has an endless shape and is wound around a plurality of rollers 32 to be set in a posture. In this embodiment, the intermediate transfer belt 31 has the posture of an inverted obtuse triangle shape which is long in the apparatus width direction in a front view. Among the plurality of rollers 32, a roller 32D illustrated in FIG. 1 functions as a driving roller that applies power of a motor (not illustrated) to circulate the intermediate transfer belt 31 in a direction of the arrow A. The intermediate transfer belt 31 circulates in the direction of the arrow A to transport the primarily transferred images to the secondary transfer position NT.

Among the plurality of rollers 32, a roller 32T illustrated in FIG. 1 functions as a tensioning roller that tensions the intermediate transfer belt 31. Among the rollers 32, a roller 32B illustrated in FIG. 1 functions as a counter roller of the secondary transfer roller 34. An obtuse lower apex portion of the intermediate transfer belt 31 in the posture of the inverted obtuse triangular shape as described above is wound around the counter roller 32B. The intermediate transfer belt 31 is in contact with the photosensitive drums 21 of the respective colors from below at an upper side portion extending in the apparatus width direction in the above-described posture.

### [Primary Transfer Roller]

The primary transfer rollers 33 are rollers that transfer the toner images on the photosensitive drums 21 to the intermediate transfer belt 31, and are disposed on the inner side of the intermediate transfer belt 31. Each of the primary transfer rollers 33 is disposed to oppose the photosensitive drum 21 of the corresponding color with the intermediate transfer belt 31 interposed therebetween. A primary transfer voltage having a polarity opposite to a toner polarity is applied to the primary transfer roller 33 by a power supply unit (not illustrated). With the application of the primary transfer voltage, the toner image formed on the photosensitive drum 21 is transferred to the intermediate transfer belt 31 at a primary transfer position T between the photosensitive drum 21 and the primary transfer roller 33.

### [Secondary Transfer Belt]

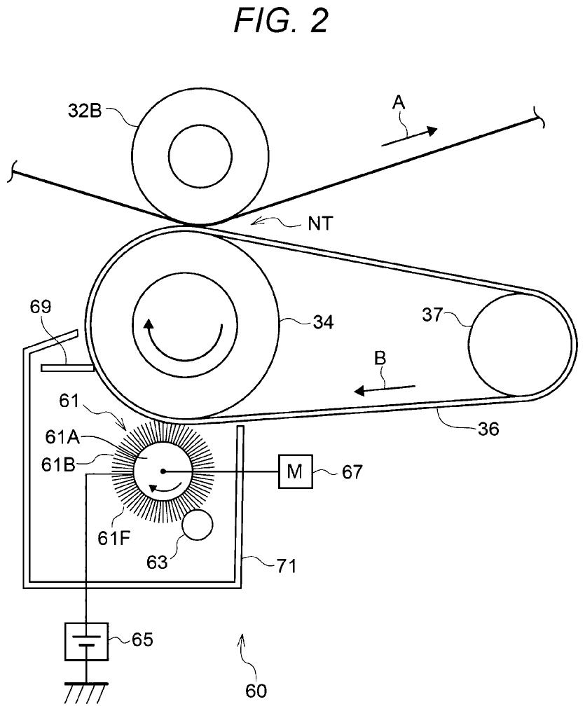

The secondary transfer belt 36 is a belt that transfers the toner images superimposed on the intermediate transfer belt 31 to the recording medium P. As illustrated in FIG. 2, the secondary transfer belt 36 has an endless shape and is wound around a secondary transfer roller 34 and a driven roller 37.

The secondary transfer roller 34 is disposed so as to interpose the intermediate transfer belt 31 and the secondary transfer belt 36 with the counter roller 32B, and the secondary transfer belt 36 and the intermediate transfer belt 31 come into contact with each other with a preset load. The secondary transfer position NT is located between the secondary transfer belt 36 and the intermediate transfer belt 31 in contact with each other in this manner. The recording medium P is supplied from the container 51 (see FIG. 1) to the secondary transfer position NT on time. The secondary transfer belt 36 is moved to circulate in a direction of an arrow B by rotationally driving the secondary transfer roller 34. Note that a configuration of the secondary transfer belt 36 will be described later.

In the first embodiment, when a toner image on the intermediate transfer belt 31 are transferred onto the recording medium P, a negative voltage is applied to the counter roller 32B by a power supply unit 39 (see FIG. 1). As a result, a potential difference is generated between the counter roller 32B and the secondary transfer roller 34. That is, when the negative voltage is applied to the counter roller 32B, a secondary transfer voltage (positive voltage) having a polarity opposite to the toner polarity is indirectly applied to the secondary transfer roller 34 serving as a counter electrode of the counter roller 32B. As a result, the negative toner image is transferred from the intermediate transfer belt 31 to the recording medium P slipping through the secondary transfer position NT.

On the other hand, a positive voltage is applied to the counter roller 32B by the power supply unit 39 in a case where a toner is held on the intermediate transfer belt 31 when the toner on the intermediate transfer belt 31 passes through the secondary transfer position NT. As a result, a potential difference is generated between the counter roller 32B and the secondary transfer roller 34. That is, when the positive voltage is applied to the counter roller 32B, a non-transfer voltage (negative voltage) having the same polarity as the toner polarity is indirectly applied to the secondary transfer roller 34 serving as the counter electrode of the counter roller 32B. As a result, the toner slipping through the secondary transfer position NT receives a repulsive force from the secondary transfer roller 34 and is held by the intermediate transfer belt 31. For example, in a case where a patch of the toner (an image for detection) is formed on the intermediate transfer belt 31 to detect an image density and a color shift, the patch is held by the intermediate transfer belt 31 when the patch on the intermediate transfer belt 31 passes through the secondary transfer position NT. In FIG. 1, reference 49 denotes a detection unit that detects the image density and the color shift.

### [Cleaning Device for Intermediate Transfer Belt]

As illustrated in FIG. 1, the cleaning device 35 is disposed on the downstream side of the secondary transfer position NT and on the upstream side of a primary transfer position T (Y) in a circulating direction of the intermediate transfer belt 31. The cleaning device 35 includes a blade 351 that scrapes off a toner remaining on a surface of the intermediate transfer belt 31 from the surface of the intermediate transfer belt 31. For example, when a patch is formed on the intermediate transfer belt 31, the patch is scraped off by the blade 351. The cleaning device 35 may include a cleaning brush in addition to the blade 351.

### (Operation of Image Forming Apparatus)

Next, an operation of the image forming apparatus 10 will be described.

When the control unit 70 receives an image formation command (print command), the control unit 70 causes toner image forming units 20Y to 20K, the transfer device 30, and the fixing device 40 to operate as follows (see FIG. 1).

In the toner image forming units 20Y to 20K, the photosensitive drums 21 of the respective colors are charged by the chargers 22 while being rotated. The charged photosensitive drums 21 are exposed to light by the exposure devices 23 so that electrostatic latent images are formed on the surfaces of the photosensitive drums 21, respectively. The electrostatic latent images formed on the photosensitive drums 21 are developed using developers supplied from the developing devices 24, respectively. As a result, toner images of yellow (Y), magenta (M), cyan (C), and black (K) are formed on photosensitive drums 21Y to 21K of the respective colors.

The toner images formed on the respective photosensitive drums 21 are sequentially transferred by the primary transfer rollers 33, respectively, onto the circulating intermediate transfer belt 31. The toner images transferred to the intermediate transfer belt 31 are transported to the secondary transfer position NT by the circulation of the intermediate transfer belt 31.

The recording medium P is supplied to the secondary transfer position NT by the transport rollers 52 in accordance with a timing at which the toner images are transferred. When the recording medium P passes through the secondary transfer position NT, the secondary transfer voltage (voltage having the positive polarity) is applied to the secondary transfer roller 34 via the counter roller 32B. As a result, the toner images are transferred from the intermediate transfer belt 31 to the recording medium P.

The recording medium P to which the toner images have been transferred is transported from the secondary transfer position NT to the fixing device 40 by the transport belt 58, and the toner images on the recording medium P are fixed to the recording medium P in the fixing device 40. An adherent substance such as the toner remaining on the intermediate transfer belt 31 after the secondary transfer is removed by the blade 351 and the cleaning brush of the cleaning device 35.

### (Secondary Transfer Belt and Cleaning Device for Secondary Transfer Belt)

Next, configurations of the secondary transfer belt 36 and the cleaning device 60 for the secondary transfer belt 36, which are main parts of the present disclosure, will be described.

As illustrated in FIG. 2, the cleaning device 60 includes a cleaning brush 61 as an example of a cleaning member that cleans a surface of the secondary transfer belt 36. For example, the cleaning brush 61 comes into contact with the surface of the secondary transfer belt 36 and removes a toner on the surface of the secondary transfer belt 36. The cleaning brush 61 is an example of a brush member. In the first embodiment, the cleaning brush 61 is a roller brush having a cylindrical shape. As an example, the cleaning brush 61 is provided at a portion where the secondary transfer belt 36 is wound around the secondary transfer roller 34. In the following description, “cleaning a surface of a belt” is synonymous with “removing or collecting an adherent substance such as a toner from the belt”.

In the first embodiment, the cleaning device 60 includes a power supply unit 65 that applies a bias voltage (cleaning voltage) having a positive polarity to a shaft portion 61A, which will be described later, of the cleaning brush 61. As a result, the cleaning brush 61 attracts and cleans the toner on the secondary transfer belt 36 by an electrostatic force according to the bias voltage applied from the power supply unit 65.

In addition, the cleaning device 60 includes a flicking bar 63 that has a cylindrical shape, comes into contact with a brush portion 61B, which will be described later, of the cleaning brush 61 and flicks bristles 61F. Note that other members such as a roller-shaped brush may be used without being limited to the flicking bar 63 as long as the toner of the cleaning brush 61 is removed.

The cleaning device 60 includes a blade 69 that scrapes off the toner remaining on the surface of the secondary transfer belt 36 from the surface of the secondary transfer belt 36 on the downstream side of the cleaning brush 61 in a circulating direction of the secondary transfer belt 36 and on the upstream side of the secondary transfer position NT.

The cleaning device 60 is provided with a receiving portion 71 so as to surround the cleaning brush 61, the flicking bar 63, and the blade 69 between the cleaning device 60 and the secondary transfer belt 36, and is configured such that the toner removed from the secondary transfer belt 36 falls into the receiving portion 71.

### [Configuration of Secondary Transfer Belt]

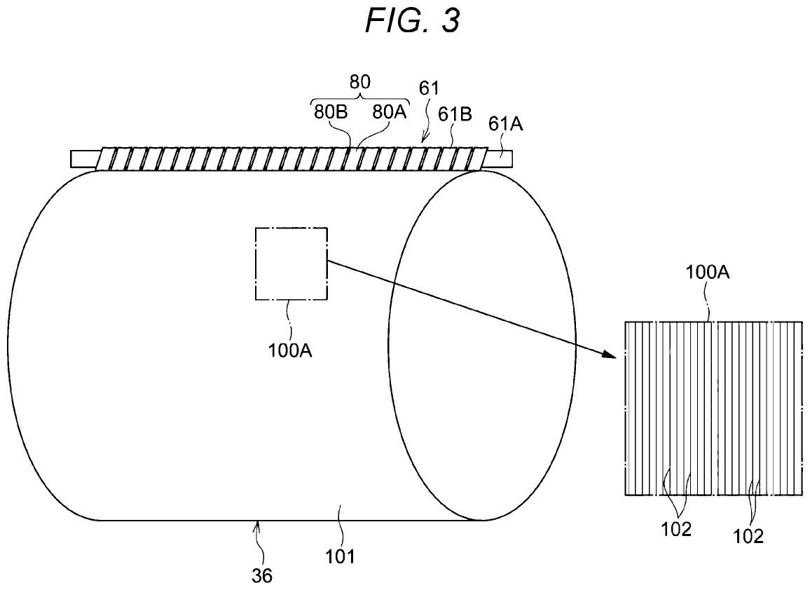

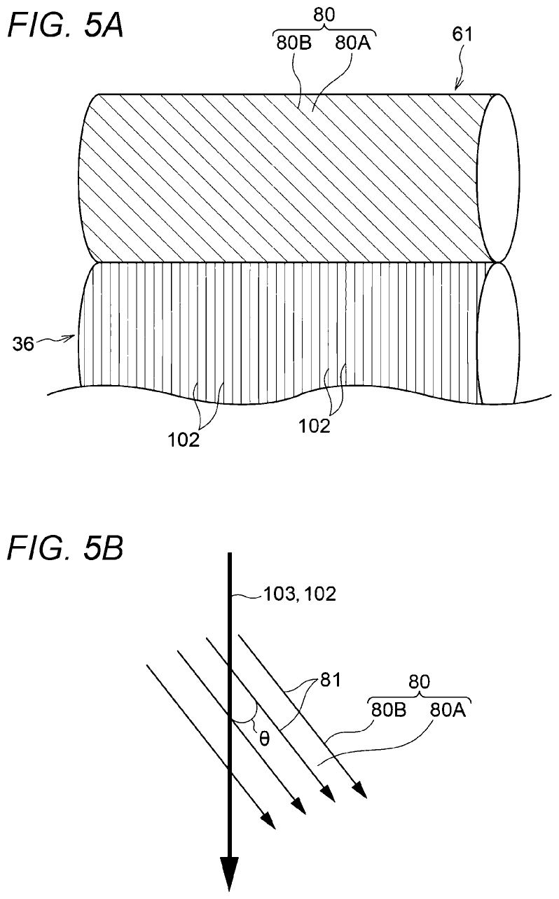

As illustrated in FIG. 3, the secondary transfer belt 36 includes a plurality of grooves 102 formed along a circumferential direction (see FIG. 5). FIG. 3 illustrates a region 100A in which a part of an outer circumferential surface of the secondary transfer belt 36 is enlarged, and the plurality of grooves 102 are provided in the enlarged region 100A. Although an accurate positional relationship is not illustrated in FIG. 3 so as to facilitate easy understanding of the configuration, the plurality of grooves 102 are formed along the circumferential direction of the secondary transfer belt 36, and the plurality of grooves 102 are disposed at regular intervals in a width direction of the secondary transfer belt 36.

The secondary transfer belt 36 includes a viscoelastic layer 101 on the surface thereof. Although not illustrated, the secondary transfer belt 36 may include the viscoelastic layer 101 on a surface of an endless substrate. In the first embodiment, the plurality of grooves 102 are formed on a surface of the viscoelastic layer 101 along the circumferential direction. As an example, the plurality of grooves 102 are formed to be substantially continuous along the circumferential direction.

A ten-point average roughness Rz of the surface of the viscoelastic layer 101 is preferably in a range of 1 μm to 10 μm, more preferably in a range of 2 μm to 8 μm, and even more preferably in a range of 3 μm to 6 μm. Here, the ten-point average roughness Rz is a ten-point average roughness Rz measured conforming to JIS B 0601:1994. The ten-point average roughness Rz is measured with a contact surface roughness meter (SURFCOM 570A manufactured by Tokyo Seimitsu Co., Ltd.) at 23° C. and 55% RH. The measurement is performed by setting a measurement distance to 2.5 mm and using a contact needle having a diamond tip (5 μmR and 90° cone), and an average value thereof is calculated. In the case of an axial direction, the ten-point average roughness Rz is, for example, an average value of values obtained by dividing the surface in the axial direction into six equal portions and measuring the center portion among the six equal portions. In the case of the circumferential direction, for example, the ten-point average roughness Rz is an average value of values obtained by dividing the surface at the center portion in the axial direction in the circumferential direction into six equal portions and measuring a center position among the six equal portions.

An aspect ratio Str of a surface property of the viscoelastic layer 101 of the secondary transfer belt 36 is preferably less than 0.5, more preferably less than 0.45, and even more preferably less than 0.4. Here, the aspect ratio Str of the surface property is a parameter of the surface property defined in ISO 25178, and represents isotropy and anisotropy of the surface property. The aspect ratio Str of the surface property is a value from 0 to 1, and indicates that there is a streak or the like when being close to 0, and indicates that the surface is independent of a direction when being close to 1. The maximum height on the surface of the viscoelastic layer 101 is set based on an average particle diameter of toners used in the image forming apparatus 10. A measurement device, measurement conditions, and the like are as follows.
Measurement device: VK X3000 shape analysis laser microscope manufactured by Keyence Corporation
Measurement range: 1.06 mm×1.42 mm
Measurement conditions: Gaussian filter is used
S filter: not used
L filter: 0.1 mm

Therefore, the interval of the plurality of grooves 102 (that is, a pitch of the plurality of grooves 102) is preferably 60 μm or less, more preferably 50 μm or less, and even more preferably 45 μm or less.

### [Configuration of Cleaning Brush]

As illustrated in FIG. 2, the cleaning brush 61 has the shaft portion 61A made of metal and the brush portion 61B made of a synthetic resin and provided on the outer circumference of the shaft portion 61A over the entire circumference thereof. In the brush portion 61B, a large number of the bristles 61F extend in a radial direction (radially outward direction) from the shaft portion 61A. The shaft portion 61A is an example of a cylindrical portion, and the bristles 61F are an example of brush hair.

The cleaning brush 61 is rotated when the shaft portion 61A is rotationally driven by a rotational driving device 67 such as a motor. The cleaning brush 61 is an example of a rotating member and rotates in contact with the surface of the secondary transfer belt 36. As an example, the cleaning brush 61 rotates in the same direction as the circulating direction of the secondary transfer belt 36 (the clockwise direction in FIG. 2). In other words, the cleaning brush 61 rotates in a direction opposite to the circulating direction of the secondary transfer belt 36 in a contact portion between the cleaning brush 61 and the secondary transfer belt 36.

Note that the rotational driving device 67 may rotate the cleaning brush 61 in a direction opposite to the circulating direction of the secondary transfer belt 36 (in the counterclockwise direction in FIG. 2). When rotating in the direction opposite to the circulating direction of the secondary transfer belt 36, for example, the cleaning brush 61 preferably rotates with a circumferential velocity difference from a circumferential velocity of the secondary transfer belt 36.

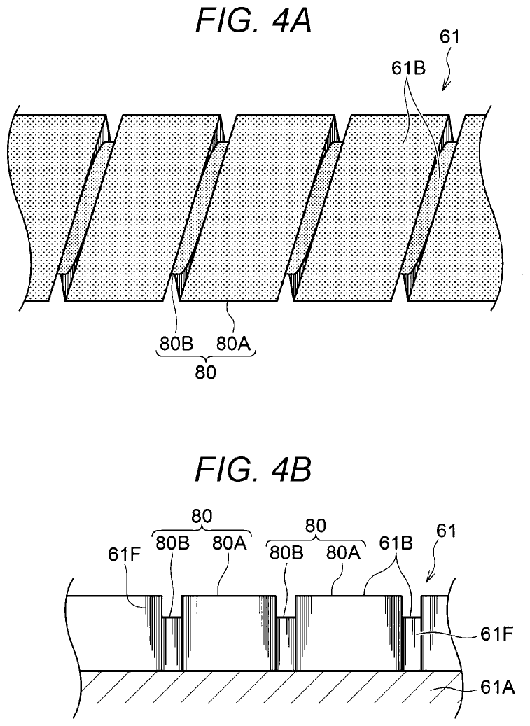

As illustrated in FIGS. 3, 4A, and 4B, the cleaning brush 61 includes a plurality of projections and recesses 80 extending in a direction intersecting the grooves 102 on a contact surface with the secondary transfer belt 36. The projection and recess 80 include a projection 80A in which a length of the bristle 61F is long and a recess 80B in which a length of the bristle 61F is short by varying the lengths of the bristles 61F disposed along the radial direction. The plurality of projections and recesses 80 have a configuration in which the projection 80A and the recess 80B are alternately disposed along the axial direction of the cleaning brush 61.

A difference in height of the projection and recess 80 in the cleaning brush 61, that is, a difference in height between the projection 80A and the recess 80B is preferably 100 μm or more and 1 mm or less, more preferably 200 μm or more and 800 μm or less, and even more preferably 300 μm or more and 500 μm or less.

As an example, the projections and recesses 80 are spirally formed on a circumferential surface of the cleaning brush 61 (see FIG. 4A). In the first embodiment, the cleaning brush 61 includes the projections and recesses 80 formed spirally by varying the lengths of the bristles 61F (see FIGS. 4A and 4B). As a result, the plurality of projections and recesses 80 are provided along the axial direction on the contact surface of the cleaning brush 61 with the secondary transfer belt 36.

As illustrated in FIG. 5A, the projections and recesses 80 of the cleaning brush 61 and the grooves 102 of the secondary transfer belt 36 intersect each other in the contact portion where the cleaning brush 61 is in contact with the surface of the secondary transfer belt 36. As illustrated in FIG. 5B, a direction 81 of the projections and recesses 80 of the cleaning brush 61 and a direction 103 of the grooves 102 of the secondary transfer belt 36 intersect each other at an angle θ in the contact portion between the cleaning brush 61 and the secondary transfer belt 36 in a plan view.

In the contact portion where the cleaning brush 61 is in contact with the surface of the secondary transfer belt 36, the angle θ at which the projections and recesses 80 and the grooves 102 intersect each other is preferably 45 degrees or smaller, more preferably 43 degrees or smaller, and even more preferably 41 degrees or smaller. For example, the angle θ at which the projections and recesses 80 and the grooves 102 intersect each other is 40 degrees in the contact portion where the cleaning brush 61 is in contact with the surface of the secondary transfer belt 36.

As an example, the brush portion 61B of the cleaning brush 61 is in contact with the secondary transfer belt 36 in a state of biting into the secondary transfer belt 36, and the amount of bite of the brush portion 61B is larger than an upper limit of the difference in height of the projection and recess 80, that is, the difference in height of the projection 80A and the recess 80B. As a result, both the projection 80A and the recess 80B of the cleaning brush 61 come into contact with the surface of the secondary transfer belt 36.

### Action of First Embodiment

Next, action of the first embodiment will be described.

Since the secondary transfer belt 36 and the intermediate transfer belt 31 come into contact with each other with the preset load in the image forming apparatus 10, there is a case where a part of a toner held on the intermediate transfer belt 31 is transferred to the secondary transfer belt 36 through which the recording medium P does not pass. In particular, in a case where a patch of the toner is formed on the surface of the intermediate transfer belt 31 in order to adjust the image density and the color shift, a part of the toner of the patch is sometimes transferred to the secondary transfer belt 36 even when a voltage having a polarity opposite to that at the time of transfer is applied by the power supply unit 39. As a result, the toner adheres to the surface of the secondary transfer belt 36.

The toner adhering to the secondary transfer belt 36 is transported to the cleaning device 60 as the secondary transfer belt 36 circulates. The cleaning device 60 includes the cleaning brush 61 that comes into contact with the surface of the secondary transfer belt 36, and the cleaning brush 61 cleans the surface of the secondary transfer belt 36 to remove (that is, collect) the adherent substance such as the toner on the surface of the secondary transfer belt 36.

The secondary transfer belt 36 includes the plurality of grooves 102 along the circumferential direction. In addition, the cleaning brush 61 includes the plurality of projections and recesses 80 extending in the direction intersecting the grooves 102 on the contact surface with the secondary transfer belt 36. As a result, the plurality of grooves 102 of the secondary transfer belt 36 and the plurality of projections and recesses 80 of the cleaning brush 61 intersect each other in the contact portion where the cleaning brush 61 is in contact with the surface of the secondary transfer belt 36. The cleaning brush 61 is displaced in the axial direction by the rotation of the plurality of projections and recesses 80 and rotates while intersecting the plurality of grooves 102 of the secondary transfer belt 36, so that a site having a high contact pressure and a site having a low contact pressure with respect to the secondary transfer belt 36 move in the axial direction as the cleaning brush 61 rotates. That is, the contact pressure of the cleaning brush 61 against the secondary transfer belt 36 repeatedly increases and decreases in the axial direction. As a result, it is possible to prevent the adherent substance such as the toner from slipping through the contact portion between the cleaning brush 61 and the secondary transfer belt 36 and to reduce excessive frictional resistance, so that it is possible to obtain excellent durability characteristics.

In general, in a case where a diameter of a cleaning member is constant along the axial direction in a configuration in which the cleaning member such as a cleaning brush comes into contact with a secondary transfer belt, an adherent substance such as a toner sometimes slips through a portion where a close contact property is deteriorated due to a change in shape of a recessed portion where the cleaning member is in contact with the secondary transfer belt. In addition, cleaning performance and durability performance are sometimes deteriorated due to friction between the cleaning member and the secondary transfer belt.

In contrast, in the image forming apparatus 10 according to the first embodiment, the plurality of grooves 102 of the secondary transfer belt 36 and the plurality of projections and recesses 80 of the cleaning brush 61 intersect each other in the contact portion between the cleaning brush 61 and the secondary transfer belt 36. As a result, the contact pressure of the cleaning brush 61 against the secondary transfer belt 36 repeatedly increases and decreases in the axial direction as the cleaning brush 61 rotates. Thus, it is possible to prevent the adherent substance such as the toner from slipping through the contact portion between the cleaning brush 61 and the secondary transfer belt 36 and to reduce excessive frictional resistance.

Therefore, the image forming apparatus 10 can suppress suppressing deterioration due to abrasion while improving cleaning performance of the secondary transfer belt 36 as compared with a case where the plurality of grooves and the projections and recesses do not intersect each other on the contact surface between the transport member including the grooves in the circumferential direction and the cleaning member including the projections and recesses.

In addition, in the image forming apparatus 10, the angle θ at which the projections and recesses 80 and the grooves 102 intersect each other is 45 degrees or smaller in the contact portion where the cleaning brush 61 is in contact with the surface of the secondary transfer belt 36. As a result, the contact pressure of the cleaning brush 61 against the secondary transfer belt 36 tends to repeatedly increase and decrease in the axial direction in the contact portion between the cleaning brush 61 and the secondary transfer belt 36. Thus, the image forming apparatus 10 can suppress the deterioration due to the abrasion while improving the cleaning performance of the secondary transfer belt 36 as compared with a case where the angle at which the projections and recesses of the cleaning member and the grooves of the secondary transfer belt intersect with each other is larger than 45 degrees.

In the image forming apparatus 10, the difference in height of the projections and recesses 80 in the cleaning brush 61 is 100 μm or more and 1 mm or less. Thus, in the image forming apparatus 10, the toner is prevented from slipping through the contact portion between the cleaning brush 61 and the secondary transfer belt 36 as compared with a case where the difference in height of the projections and recesses in the cleaning member is larger than 1 mm. In addition, it is possible to suppress the deterioration due to the abrasion while improving the cleaning performance of the secondary transfer belt 36 as compared with a case where a maximum difference in height of the projections and recesses in the cleaning member is smaller than 100 μm.

In the image forming apparatus 10, the brush portion 61B of the cleaning brush 61 is in contact with the secondary transfer belt 36 in the state of biting into the secondary transfer belt 36, and the amount of bite of the brush portion 61B is larger than an upper limit of the difference in height of the projection and recess 80, that is, the difference in height of the projection 80A and the recess 80B. As a result, both the projection 80A and the recess 80B of the cleaning brush 61 come into contact with the secondary transfer belt 36. Thus, the image forming apparatus 10 can suppress the deterioration due to the abrasion while improving the cleaning performance of the secondary transfer belt 36 as compared with a case where the amount of bite of the cleaning brush is smaller than the upper limit of the difference in height.

In addition, in the image forming apparatus 10, the cleaning brush 61 is a rotating member that rotates in contact with the surface of the secondary transfer belt 36, and the projections and recesses 80 are spirally formed on the circumferential surface of the cleaning brush 61. As a result, the spiral projections and recesses 80 of the cleaning brush 61 rotate while intersecting the plurality of grooves 102 of the secondary transfer belt 36, so that the site having the high contact pressure and the site having the low contact pressure with respect to the secondary transfer belt 36 move in the axial direction as the cleaning brush 61 rotates. Thus, the image forming apparatus 10 can suppress the deterioration due to the abrasion while improving the cleaning performance of the secondary transfer belt 36 as compared with a case where the cleaning member is formed of a non-rotating member.

In addition, in the image forming apparatus 10, the cleaning brush 61 is provided with the bristles 61F, which come into contact with the surface of the secondary transfer belt 36, on the surface of the shaft portion 61A, and the projections and recesses 80 are spirally formed in accordance with the lengths of the bristles 61F. As a result, the bristles 61F of the cleaning brush 61 easily come into contact with the adherent substance such as the toner on the secondary transfer belt 36 by the rotation of the cleaning brush 61. Thus, in the image forming apparatus 10, the toner is prevented from slipping through the contact portion of the cleaning brush 61 with respect to the secondary transfer belt 36 as compared with a case where the projections and recesses are formed using a resin on the cleaning member.

In the image forming apparatus 10, the viscoelastic layer 101 is provided on the surface of the secondary transfer belt 36, and the ten-point average roughness Rz of the viscoelastic layer 101 is 1 μm or more and 10 μm or less. Thus, in the image forming apparatus 10, the toner is prevented from slipping through the contact portion between the secondary transfer belt 36 and the cleaning brush 61 as compared with a case where the ten-point average roughness Rz of the surface of the secondary transfer belt is larger than 10 μm. In addition, it is possible to suppress the deterioration due to the abrasion while improving the cleaning performance of the secondary transfer belt 36 as compared with a case where the ten-point average roughness Rz of the surface of the secondary transfer belt is smaller than 1 μm.

In the image forming apparatus 10, the viscoelastic layer 101 is provided on the surface of the secondary transfer belt 36, and the aspect ratio Str of the surface property of the viscoelastic layer 101 is less than 0.5. In a case where the aspect ratio Str of the surface property of the viscoelastic layer 101 is less than 0.5, the plurality of grooves 102 such as streaks are present on the surface of the viscoelastic layer 101. As the aspect ratio Str of the surface property of the viscoelastic layer is close to 1, the surface of the viscoelastic layer becomes independent of the direction. Thus, the image forming apparatus 10 can suppress the deterioration due to the abrasion while improving the cleaning performance of the secondary transfer belt 36 as compared with a case where the aspect ratio Str of the surface property of the secondary transfer belt is 0.5 or more.

### Second Embodiment

Next, an image forming apparatus according to a second embodiment will be described. Constituent portions similar to those in the above-described first embodiment will be denoted by the same references, and descriptions thereof will be omitted.

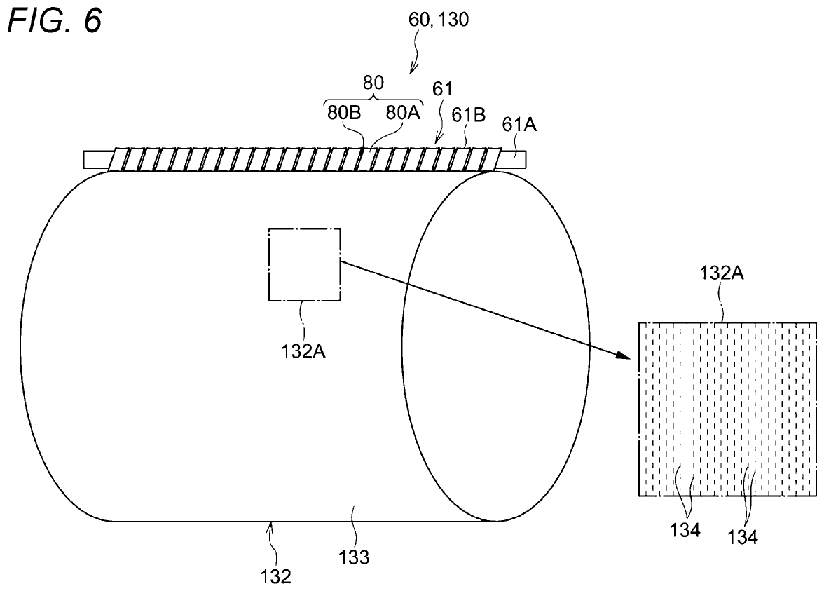

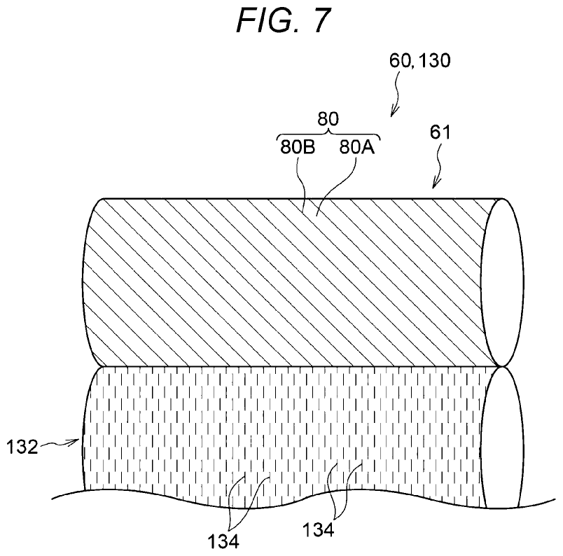

As illustrated in FIGS. 6 and 7, a cleaning portion of the cleaning device 60 of an image forming apparatus 130 according to the second embodiment is different from that of the first embodiment in terms of a configuration of a secondary transfer belt 132 as an example of a transport member. The secondary transfer belt 132 has an endless shape and includes a viscoelastic layer 133 on a surface thereof. In the second embodiment, a plurality of grooves 134 are formed on the surface of the viscoelastic layer 133 along the circumferential direction. As an example, the plurality of grooves 134 are formed at intervals in the circumferential direction to be discontinuous along the circumferential direction.

A ten-point average roughness Rz of the viscoelastic layer 133 is 1 μm or more and 10 μm or less. An aspect ratio Str of a surface property of the viscoelastic layer 133 is less than 0.5.

As illustrated in FIG. 7, the cleaning brush 61 includes the plurality of projections and recesses 80 extending in a direction intersecting the grooves 134 on a contact surface with the secondary transfer belt 132. As a result, in the contact portion where the cleaning brush 61 is in contact with the surface of the secondary transfer belt 132, the plurality of grooves 134 of the secondary transfer belt 132 and the plurality of projections and recesses 80 of the cleaning brush 61 intersect each other. Other configurations of the image forming apparatus 130 are the same as those of the image forming apparatus 10 according to the first embodiment.

In the image forming apparatus 130 of the second embodiment, similar action and effects can be obtained by similar configurations as those of the image forming apparatus 10 of the first embodiment.

### Third Embodiment

Next, an image forming apparatus according to a third embodiment will be described. Constituent portions similar to those in the above-described first and second embodiments will be denoted by the same references, and descriptions thereof will be omitted.

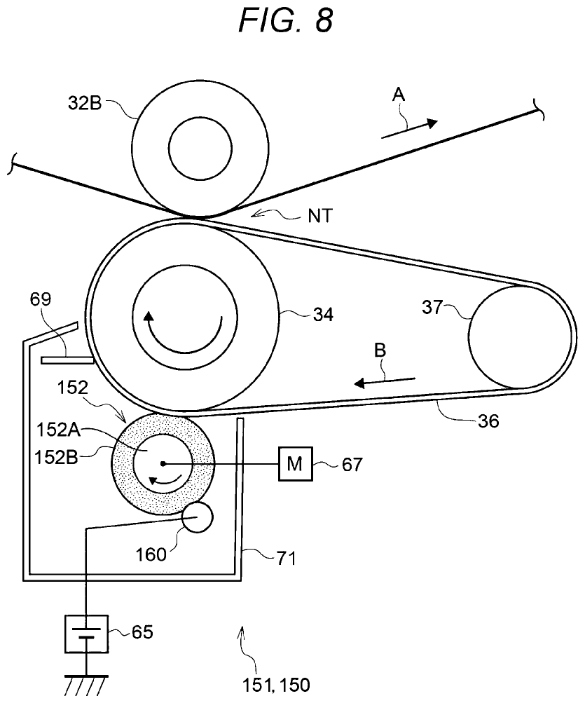

As illustrated in FIG. 8, a cleaning device 151 of an image forming apparatus 150 according to the third embodiment is different from that of the first embodiment in terms of a configuration of a cleaning roller 152 as an example of a cleaning member. The cleaning roller 152 includes a shaft portion 152A and an elastic body layer 152B provided on an outer circumferential surface of the shaft portion 152A. The cleaning roller 152 is an example of a cylindrical member. The elastic body layer 152B comes into contact with the secondary transfer belt 36 wound around the secondary transfer roller 34 while being elastically deformed in a recessed shape. The cleaning roller 152 is an example of a rotating member and rotates in contact with the surface of the secondary transfer belt 36.

As an example, the elastic body layer 152B is formed using a rubber member having conductivity, and a bias voltage (cleaning voltage) having a positive polarity is applied to the elastic body layer 152B via a power supply roller 160 which is in contact with an outer circumferential surface of the elastic body layer 152B.

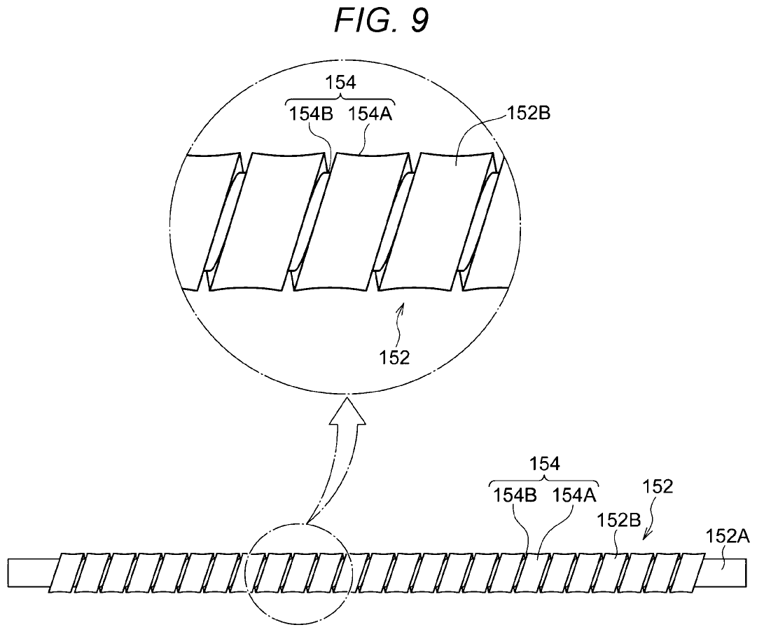

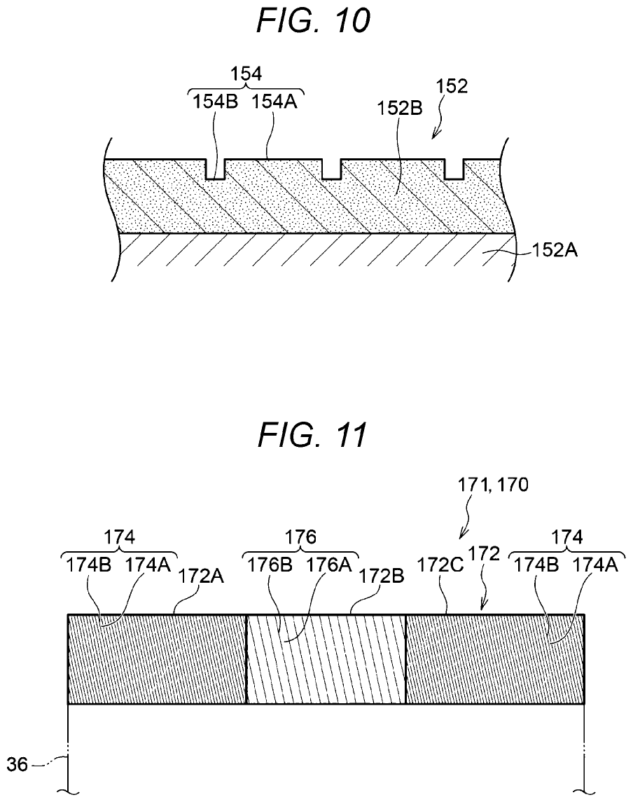

As illustrated in FIG. 9, the cleaning roller 152 includes a plurality of projections and recesses 154 extending in a direction intersecting the grooves 102 (see FIG. 3) on a contact surface with the secondary transfer belt 36. In the projection and recess 154, a projection 154A having a larger height in the radial direction of the elastic body layer 152B and a recess 154B having a smaller height in the radial direction of the elastic body layer 152B are formed by varying thicknesses in the radial direction of the elastic body layer 152B (see FIG. 10). The plurality of projections and recesses 154 have a configuration in which the projection 154A and the recess 154B are alternately disposed along the axial direction of the cleaning roller 152.

A difference in height of the projection and recess 154 in the cleaning roller 152, that is, a difference in height between the projection 154A and the recess 154B is preferably 100 μm or more and 1 mm or less, more preferably 200 μm or more and 800 μm or less, and even more preferably 300 μm or more and 500 μm or less.

As an example, the projections and recesses 154 are spirally formed on a circumferential surface of the cleaning roller 152, and the projections and recesses 154 of the cleaning roller 152 and the grooves 102 (see FIG. 3) of the secondary transfer belt 36 intersect each other in a contact portion where the cleaning roller 152 is in contact with the surface of the secondary transfer belt 36.

The elastic body layer 152B of the cleaning roller 152 bites into the secondary transfer belt 36 (see FIG. 8). The amount of bite of the elastic body layer 152B into the secondary transfer belt 36 is larger than an upper limit of the difference in height of the projection and recess 154, that is, the difference in height between the projection 154A and the recess 154B. As a result, both the projection 154A and the recess 154B of the elastic body layer 152B come into contact with the surface of the secondary transfer belt 36. Other configurations of the image forming apparatus 150 are the same as those of the image forming apparatus 10 according to the first embodiment.

In the image forming apparatus 150 of the third embodiment, the following action and effects are obtained in addition to the action and effects obtained by the configurations similar to those of the image forming apparatus 10 of the first embodiment.

In the image forming apparatus 150, the elastic body layer 152B of the cleaning roller 152 bites into the secondary transfer belt 36, and the amount of bite of the elastic body layer 152B is larger than the upper limit of the difference in height between the projection and recess 154. Thus, the image forming apparatus 150 can suppress the deterioration due to the abrasion while improving the cleaning performance of the secondary transfer belt 36 as compared with a case where the amount of bite of the cleaning roller is smaller than the upper limit of the difference in height.

In the image forming apparatus 150, the cleaning roller 152 is the cylindrical member including the elastic body layer 152B that comes into contact with the surface of the secondary transfer belt 36, and the projections and recesses 154 are spirally formed on the elastic body layer 152B. Thus, the cleaning roller 152 is easily manufactured in the image forming apparatus 150 as compared with a case where the projections and recesses are formed using brush hair on the cleaning member.

### Fourth Embodiment

Next, an image forming apparatus according to a fourth embodiment will be described. Constituent portions similar to those in the above-described first to third embodiments will be denoted by the same references, and descriptions thereof will be omitted.

As illustrated in FIG. 11, a cleaning device 171 of an image forming apparatus 170 according to the fourth embodiment is different from that of the first embodiment in terms of a configuration of a cleaning brush 172 as an example of a cleaning member. The cleaning brush 172 is formed to be divided into three or more portions along the width direction of the secondary transfer belt 36. For example, the cleaning brush 172 includes a first divided portion 172A, a second divided portion 172B, and a third divided portion 172C which are examples of the three divided portions, respectively. The first divided portion 172A and the third divided portion 172C are disposed at both ends of the secondary transfer belt 36 in the width direction, and the second divided portion 172B is disposed on the inner side of both the ends of the secondary transfer belt 36 in the width direction (in the fourth embodiment, at the center portion of the secondary transfer belt 36 in the width direction).

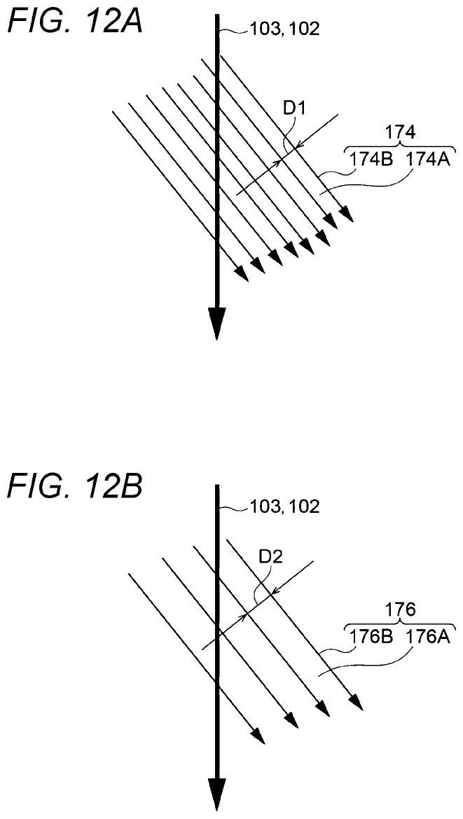

As illustrated in FIGS. 11 to 12B, each of the first divided portion 172A and the third divided portion 172C includes a plurality of projections and recesses 174 extending in a direction intersecting the grooves 102 on a contact surface with the secondary transfer belt 36. The projection and recess 174 are examples of irregularities and include a recess 174B and a projection 174A. The second divided portion 172B includes a plurality of projections and recesses 176 extending in a direction intersecting the grooves 102 on a contact surface with the secondary transfer belt 36. The projection and recess 176 are examples of irregularities and include a recess 176B and a projection 176A.

An interval D1 in the projections and recesses 174 in the first divided portion 172A and the third divided portion 172C is smaller than an interval D2 in the projections and recesses 176 in the second divided portion 172B (see FIGS. 12A and 12B). Other configurations of the image forming apparatus 170 are the same as those of the image forming apparatus 10 according to the first embodiment.

In the image forming apparatus 170 of the fourth embodiment, the following action and effects are obtained in addition to the action and effects obtained by the configurations similar to those of the image forming apparatus 10 of the first embodiment.

In the image forming apparatus 170, the cleaning brush 172 is formed to be divided into the three portions along the width direction of the secondary transfer belt 36. The interval D1 in the projections and recesses 174 in the first divided portion 172A and the third divided portion 172C that come into contact with both the ends of the secondary transfer belt 36 in the width direction is smaller than the interval D2 in the projections and recesses 176 in the second divided portion 172B that comes into contact with the inner side of both the ends of the secondary transfer belt 36 in the width direction. Thus, in the image forming apparatus 170, even if the cleaning brush 172 is bent or the like, removal performance at both the ends of the secondary transfer belt 36 in the width direction can be maintained as compared with a case where an interval between irregularities in the divided portions, which come into contact with both the ends of the secondary transfer belt in the width direction, of the cleaning member is equal to an interval between irregularities in the divided portion, which comes into contact with the center portion of the secondary transfer belt in the width direction, of the cleaning member.

### Supplementary Description

Although the cleaning brush 61 comes into contact with the secondary transfer belt 132 in the second embodiment, the present disclosure is not limited to such a configuration. For example, the cleaning roller 152 may be configured to come into contact with the secondary transfer belt 132.

Although the cleaning brush 172 is formed to be divided into the three portions along the width direction of the secondary transfer belt 36 in the fourth embodiment, the present disclosure is not limited to such a configuration. For example, a cleaning roller may be divided into three portions along the width direction of the secondary transfer belt 36, and an interval between irregularities in divided portions, which come into contact with both the ends of the secondary transfer belt 36 in the width direction, of the cleaning roller that contacts may be smaller than an interval between irregularities in a divided portion, which comes into contact with the inner side of both the ends of the secondary transfer belt 36 in the width direction, of the cleaning roller.

In addition, the cleaning brush 172 divided into the three portions come into contact with the secondary transfer belt 36 in the fourth embodiment, but the present disclosure is not limited to such a configuration. For example, a cleaning member such as a cleaning brush or a cleaning roller may be divided into three or more (for example, four or five) portions along the width direction of the secondary transfer belt.

Although the cleaning brush or the cleaning roller rotates in contact with the secondary transfer belt in the first to fourth embodiments, the present disclosure is not limited to such a configuration. For example, a web-like cleaning member that does not rotate may be configured to come into contact with the secondary transfer belt. That is, a plurality of projections and recesses extending in a direction intersecting the grooves may be provided on a contact surface of the web-like cleaning member with the secondary transfer belt.

Although the first to fourth embodiments are configured such that the cleaning member such as the cleaning brush or the cleaning roller comes into contact with the surface of the secondary transfer belt to remove the adherent substance such as the toner on the surface of the secondary transfer belt, the present disclosure is not limited to such a configuration. For example, the present disclosure may be applied to a cleaning member for a transfer belt in an image forming apparatus that includes the transfer belt opposing a photosensitive member as an example of an image carrier, transports a recording medium P between the photosensitive member and the transfer belt, and transfers a toner image on the photosensitive member to the recording medium P. Specifically, a plurality of grooves may be formed along a circumferential direction of the transfer belt, and a plurality of projections and recesses extending in a direction intersecting the grooves may be provided on a contact surface of the cleaning member with the transfer belt. In addition, the present disclosure may be applied to a cleaning member that comes into contact with a roller-shaped transfer member without being limited to the transfer belt.

Although specific embodiments of the present invention have been described in detail, the present invention is not limited to such embodiments, and it is apparent to those skilled in the art that various other embodiments are possible within the scope of the present invention.

### APPENDIX

Hereinafter, preferred aspects of the present disclosure will be additionally described.

(((1)))

An image forming apparatus comprising: a transport member that moves in a circumferential direction, forms a transfer nip while transporting a medium between the transport member and an image carrier holding a toner image, and transfers the toner image to the medium, the transport member including a plurality of grooves along the circumferential direction; and a cleaning member that cleans a surface of the transport member, collects an adherent substance, and includes a plurality of projections and recesses extending in a direction intersecting the grooves on a contact surface with the transport member.

(((2)))

The image forming apparatus according to (((1))), in which the projections and recesses intersect the grooves at an angle of 45 degrees or less in a contact portion where the cleaning member comes into contact with the surface of the transport member.

(((3)))

The image forming apparatus according to (((1))) or (((2))), in which the projections and recesses of the cleaning member have a difference in height of 100 μm or more and 1 mm or less.

(((4)))

The image forming apparatus according to any one of (((1))) to (((3))), in which the cleaning member bites into the transport member, and the amount of bite is larger than an upper limit of the difference in height.

(((5)))

The image forming apparatus according to any one of (((1))) to (((4))), in which the cleaning member is a rotating member that rotates in contact with the surface of the transport member, and the projections and recesses are spirally formed on a circumferential surface of the cleaning member.

(((6)))

The image forming apparatus according to (((5))), in which the cleaning member is a brush member including brush hair, which comes into contact with the surface of the transport member, on a surface of a cylindrical portion, and the projections and recesses are spirally formed in accordance with a length of the brush hair.

(((7)))

The image forming apparatus according to (((5))), in which the cleaning member is a cylindrical member including an elastic body layer that comes into contact with the surface of the transport member, and the projections and recesses are spirally formed on the elastic body layer.

(((8)))

The image forming apparatus according to any one of ((1)) to ((7)), further comprising a viscoelastic layer on the surface of the transport member, the viscoelastic layer having a ten-point average roughness Rz of 1 μm or more and 10 μm or less.

(((9)))

The image forming apparatus according to any one of (((1))) to (((8))), further comprising a viscoelastic layer on the surface of the transport member, the viscoelastic layer having an aspect ratio Str of a surface property of less than 0.5.

(((10)))

The image forming apparatus according to any one of (((1))) to (((9))), in which the cleaning member is formed to be divided into three or more portions along a width direction of the transport member, and an interval between irregularities in a divided portion, which come into contact with both ends of the transport member in the width direction, of the cleaning member is smaller than an interval between irregularities in a divided portion, which comes into contact with an inner side of both the ends of the transport member in the width direction, of the cleaning member.

What is claimed is:

1. An image forming apparatus comprising:
a transport member that moves in a circumferential direction, forms a transfer nip while transporting a medium between the transport member and an image carrier holding a toner image, and transfers the toner image to the medium, the transport member including a plurality of grooves along the circumferential direction; and
a cleaning member that cleans a surface of the transport member, collects an adherent substance, and includes a plurality of projections and recesses extending in a direction intersecting the grooves on a contact surface with the transport member.

2. The image forming apparatus according to claim 1, wherein
the projections and recesses intersect the grooves at an angle of 45 degrees or smaller in a contact portion where the cleaning member is in contact with the surface of the transport member.

3. The image forming apparatus according to claim 1, wherein
the projections and recesses of the cleaning member have a difference in height of 100 μm or more and 1 mm or less.

4. The image forming apparatus according to claim 3, wherein
the cleaning member bites into the transport member, and an amount of bite is larger than an upper limit of the difference in height.

5. The image forming apparatus according to claim 1, wherein
the cleaning member is a rotating member that rotates in contact with the surface of the transport member, and the projections and recesses are spirally formed on a circumferential surface of the cleaning member.

6. The image forming apparatus according to claim 5, wherein
the cleaning member is a brush member including brush hair, which comes into contact with the surface of the transport member, on a surface of a cylindrical portion, and the projections and recesses are spirally formed in accordance with a length of the brush hair.

7. The image forming apparatus according to claim 5, wherein
the cleaning member is a cylindrical member including an elastic body layer that comes into contact with the surface of the transport member, and the projections and recesses are spirally formed on the elastic body layer.

8. The image forming apparatus according to claim 1, further comprising
a viscoelastic layer on the surface of the transport member, the viscoelastic layer having a ten-point average roughness Rz of 1 μm or more and 10 μm or less.

9. The image forming apparatus according to claim 1, further comprising
a viscoelastic layer on the surface of the transport member, the viscoelastic layer having an aspect ratio Str of a surface property of less than 0.5.

10. The image forming apparatus according to claim 1, wherein
the cleaning member is formed to be divided into three or more portions along a width direction of the transport member, and an interval between irregularities in a divided portion, which come into contact with both ends of the transport member in the width direction, of the cleaning member is smaller than an interval between irregularities in a divided portion, which comes into contact with an inner side of both the ends of the transport member in the width direction, of the cleaning member.
